(19) United States
(12) Patent Application Publication
(10) Pub. No.: US 2006/0151005 A1
(43) Pub. Date: Jul. 13, 2006

(54) Washing machine and washing tub cleaning method

(75) Inventors: Hyun Sook Kim, Suwon-si (KR); Seon Woo Park, Suwon-Si (KR); Jee Hun Park, Suwon-Si (KR); Seong Min Oak, Masan-Si (KR); Hyung Gyoon Kim, Suwon-Si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS. CO., LTD.

(21) Appl. No.: 11/208,707

(22) Filed: Aug. 23, 2005

(30) Foreign Application Priority Data
Jan. 13, 2005 (KR) 2005-3392

(51) Int. Cl. D06F 37/00; B08B 3/12; B08B 9/00

(52) U.S. Cl. 134/22.1; 134/33; 68/3 R; 68/5 R

(57) ABSTRACT

A method of cleaning a washing tub mounted in a water tub of a washing machine includes supplying water necessary to clean the washing tub to the water tub, and rotating the washing tub while supplying heat to the water tub by means of at least one heat supply device mounted in the washing machine. The washing tub is maintained at high temperature when the washing tub is cleaned, whereby decontamination and disinfection efficiency is improved. Also, water required to clean the washing tube is separately supplied to increase the rotating speed of a washing motor, whereby cleaning efficiency is improved.

### CROSS-REFERENCE TO RELATED APPLICATION

This application claims the benefit of Korean Patent Application No. 2005-3392, filed on Jan. 13, 2005 in the Korean Intellectual Property Office, the disclosure of which is incorporated herein by reference.

### BACKGROUND OF THE INVENTION

1. Field of the Invention

The present invention relates to a washing machine and a washing tub cleaning method, and, more particularly, to a washing machine and a washing tub cleaning method that is capable of supplying high-temperature heat to a washing tub when the washing tub is cleaned, thereby improving cleaning efficiency.

2. Description of the Related Art

Generally, a washing machine comprises a water tub, a washing tub rotatably mounted in the water tub, a water supply valve to control the flow of water supplied to the water tub, a washing motor to drive the washing tub and a pulsator. When a user places laundry into the washing tub, and then inputs a washing command, the washing machine successively performs a washing operation, a rinsing operation, and a dewatering operation.

After the washing machine is used for a long period of time, various impurities are attached to the washing tub or bacteria propagate within the washing tub. In order to solve these problems, various washing tub disinfecting methods have been proposed, one example of which is disclosed in Korean Unexamined Patent Publication No. 2001-0010111.

The conventional washing tub disinfecting method is performed as follows: a detergent and a disinfectant are placed in the washing tub, the pulsator is operated for a predetermined period of time to dissolve the detergent and the disinfectant, water is further supplied, and the pulsator is operated again to disinfect the washing tub with wash water containing detergent and disinfectant dissolved therein. In this way, the washing tub disinfecting method is performed.

When the washing tub is disinfected according to the above-mentioned method, however, the temperature of the wash water is lower than the temperature appropriate for impurity removal and disinfection (approximately 60° C.), and therefore, the washing tub is not properly cleaned and disinfected. Especially when cold water is supplied to the washing tub, decontamination and disinfection efficiency achieved by the detergent and the disinfectant are considerably lowered.

Furthermore, a large amount of water is supplied to the washing tub at once to clean the washing tub. Consequently, the washing motor must be operated at a relatively low rotating speed to protect the washing motor, and therefore, the current of water is slow. As a result, the magnitude of a mechanical force affecting the decontamination is small, and therefore, the washing tub is not properly cleaned.

### SUMMARY OF THE INVENTION

Illustrative, non-limiting embodiments overcome the above disadvantages, as well as other disadvantages not described above.

A method and apparatus consistent with the present invention is capable of maintaining a washing tub at high temperature when the washing tub is cleaned, thereby improving decontamination and disinfection efficiency.

The present invention also provides a washing machine and a washing tub cleaning method that is capable of separately supplying water required to clean the washing tube to increase the rotating speed of a washing motor, thereby improving cleaning efficiency.

In accordance with one aspect of the invention, a method of cleaning a washing tub mounted in a water tub of a washing machine, comprises: supplying water necessary to clean the washing tub to the water tub; and rotating the washing tub while supplying heat to the water tub by means of at least one heat supply device mounted in the washing machine.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a sectional view showing a drum washing machine according to an embodiment of the present invention;

FIG. 2 is a block diagram of the drum washing machine shown in FIG. 1;

FIG. 3 is a flow chart illustrating a washing tub cleaning process in the drum washing machine shown in FIGS. 1 and 2; and

FIG. 4 is a timing chart illustrating the washing tub cleaning process in the drum washing machine shown in FIGS. 1 and 2.

### DETAILED DESCRIPTION OF THE PREFERRED EMBODIMENTS

Reference will now be made in detail to the embodiment of the present invention. The embodiment is described below to explain the present invention by referring to the figures.

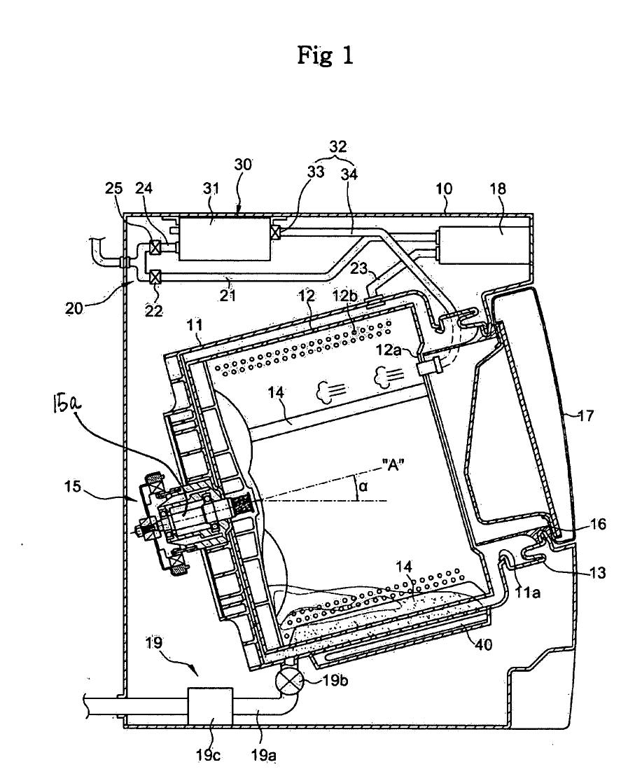

As shown in FIG. 1, the drum washing machine comprises a drum-type water tub 11 mounted in a machine body 10 to receive water, and a drum-type washing tub 12 rotatably mounted in the water tub 11.

The water tub 11 mounted in the machine body 11 is disposed at a predetermined angle (a) to the installation surface of the washing machine so that the front part of the water tub 11, at which an inlet 11a is formed, is higher than the rear part of the water tub 11. Similarly, the washing tub 12 mounted in the water tub 11 is disposed at the same angle as the water tub 11 so that the front part of the washing tub 12, at which an inlet 12a is formed, is higher than the rear part of the washing tub 12. That is, the washing tub 12 is disposed so that the rotating center line A of the washing tub 12 is at the predetermined angle (α) to the installation surface of the washing machine while the front part of the washing tub 12 having the inlet 12a formed thereat faces the front upper part of the washing machine. To the center of the rear part of the washing tub 12 is attached a rotary shaft 15a, which is rotatably supported at the center of the rear part of the water tub 11 so that the washing tub 12 is rotated in the water tub 11. At the circumferential part of the washing tub 12 are formed a plurality of through-holes 12b, and to the inner circumferential surface of the washing tub 12 are attached a plurality of lifters 14, by which the laundry is lifted and dropped when the washing tub 12 is rotated.

At the rear of the water tub 11 is mounted a washing motor 15 to rotate the rotary shaft 15a connected to the washing tub 12. At the front part of the machine body 10 is formed an inlet 16, through which the laundry is put into the washing tub 12 or removed from the washing tub 12, corresponding to the inlet 12a of the washing tub 12 and the inlet 11a of the water tub 11. The inlet 16 is closed by a door 17 hingedly attached to the front part of the machine body 10. Between the water tub 11 and the inlet 16 of the machine body is mounted a diaphragm 13.

Above the water tub 11 are mounted a detergent supply device 18 to supply a detergent to the water tub 11, a steam device 30 to supply steam to the water tub 11, a water supply device 20 to supply water to the water tub 11 and the steam device 30. Under the water tub 11 are mounted a drainage device 19, comprising a drain pipe 19a, a drain valve 19b and a drain motor 19c, to drain water from the water tub 11, and a lower heater 40 to heat water in the water tub 11.

The detergent supply device 18 has a detergent receiving space defined therein. The detergent supply device 18 is disposed at the front part of the machine body 10 so that a user can easily put detergent into the detergent supply device 18. The steam device 30 comprises a steam generator 31 to generate steam and a steam supply device 32 to supply the generated steam to the water tub. The steam supply device 32 comprises a steam supply pipe 34 connected between the steam generator 31 and the water tub 11, and a steam supply valve 33 mounted on the steam supply pipe 34. In the steam generator 31 is mounted a heater (not shown) to heat water supplied into the steam generator 31.

The water supply device 20 comprises a first water supply pipe 21 to supply water to the water tub 11, and a first water supply valve 22 mounted on the first water supply pipe 21 to control water supply through the first water supply pipe 21. The first water supply pipe 21 is connected to the detergent supply device 18 so that water supplied from outside the washing machine is supplied to the detergent supply device 18. Between the detergent supply device 18 and the water tub 11 is mounted a connection pipe 23 to supply water passing through the detergent supply device 18 to the water tub 11. In this way, water passes through the detergent supply device 18 and is then supplied to the water tub 11. As a result, the detergent in the detergent supply device 18 is supplied to the water tub while being dissolved in the water. The water supply device 20 further comprises a second water supply pipe 24 to supply water to the steam generator 31, and a second water supply valve 25 mounted on the second water supply pipe 24 to control supply of water to the steam generator 31.

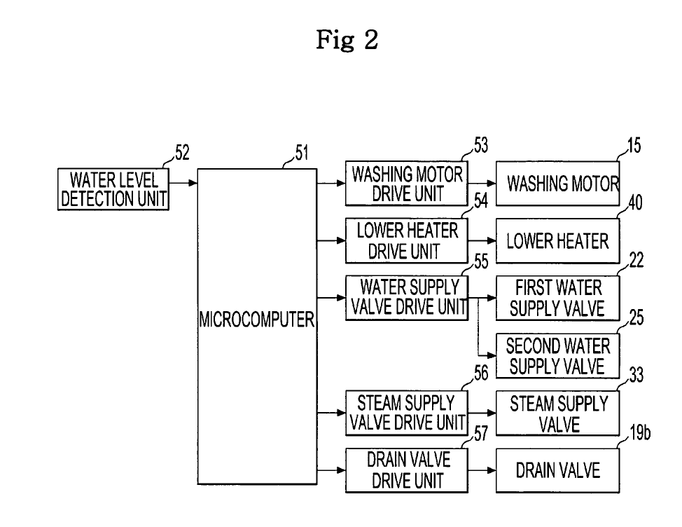

As shown in FIG. 2, the drum washing machine further comprises: a water level detection unit 52 to detect a level of water supplied to the water tub; a washing motor drive unit 53 to drive the washing motor 15; a lower heater drive unit 54 to drive the lower heater 40; a water supply valve drive unit 55 to drive the first and second water supply valves 22 and 25; a steam supply valve drive unit 56 to drive the steam supply valve 33; a drain valve drive unit 57 to drive the drain valve 19b; and a microcomputer 51 to control the respective devices of the drum washing machine.

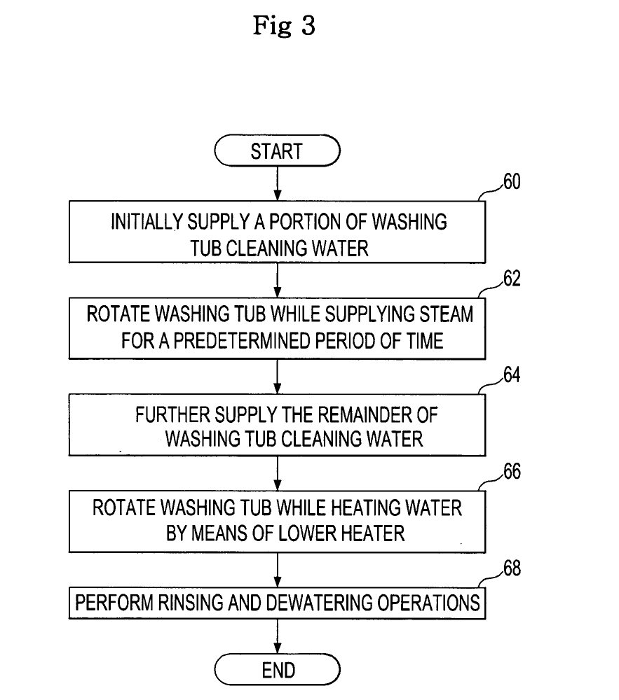

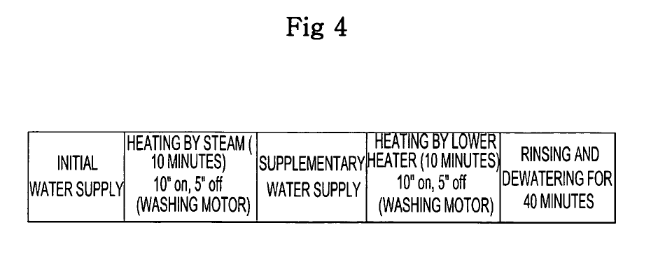

Now, a method of cleaning the washing tub of the drum washing machine shown in FIGS. 1 and 2 will be described with reference to FIGS. 3 and 4.

When a user selects a washing tub cleaning process, the first water supply valve 22 is opened to initially supply a portion of washing tub cleaning water, the amount of which is predetermined, to the water tub 11 through the detergent supply device 18 (step 60). When the water is initially supplied, it is preferable to control the amount of water to be supplied using a value detected by the water level detection unit 52 so that the water arrives at the lowest surface of the diaphragm 12 mounted at the inlet of the drum washing machine. A detergent or a disinfectant is put in the detergent supply device 18 so that water containing the detergent or the disinfectant dissolved therein is supplied to the water tub 11.

After the initial water supply is completed, the washing motor 15 is driven for a predetermined period of time (for example, repetitively turned on for 10 seconds and then off for 5 seconds—see FIG. 4) to rotate the washing tub 12, and the steam generator 31 generates steam, which is supplied to the water tub 11 and the washing tub 12 through the steam supply pipe 34 (step 62). As the steam is supplied to the water tub 11 and the washing tub 12, the interior temperature of the water tub 11 is increased, since the temperature of the steam is high, for example, above approximately 70° C., and therefore, the cleaning or disinfecting activity of the detergent or the disinfectant is activated. When the washing tub 12 is cleaned with only the initially supplied water, the washing motor 15 can be operated at a relatively high rotating speed. Consequently, strong current of flow is generated by the washing motor 15, and therefore, a cleaning force is increased.

In the illustrated embodiment, the steam is supplied while the washing tub 12 is rotated after the water is initially supplied, although various other devices may be used to increase the interior temperature of the water tub 11. For example, a drying device disclosed in Korean Unexamined Patent Publication No. 10-2004-0022828 may be used to supply hot air to the water tub and the washing tub to increase the interior temperature of the water tub.

After the initial water supply and the first cleaning are completed, the first water supply valve 22 is reopened to further supply washing tub cleaning water to the water tub 11 (step 64). While the water is heated by the lower heater 40, the washing motor 15 is driven (repetitively turned on for 10 seconds and then off for 5 seconds—see FIG. 4) to rotate the washing tub 12 (step 66). During the second cleaning, the washing tub is rotated while a great quantity of water is heated to clean the washing tub 12 and wash out various contaminants separated from the washing tub 12 during the first cleaning.

After the supplementary water supply and the second cleaning are completed, rinsing and dewatering operations are performed (step 68). In this way, the washing tub cleaning process is completed.

As apparent from the above description, the interior temperature of the water tub is highly increased as steam or hot air is supplied to the water tub when the washing tub is cleaned, and therefore, the cleaning or disinfecting activity of the detergent or the disinfectant is activated. Consequently, the present invention has the effect of cleaning and disinfection efficiency.

Also, the washing tub is cleaned only with a portion of the washing tub cleaning water during the first cleaning, and therefore, the rotating speed of the washing motor can be increased, which increases a mechanical force affecting the decontamination. Consequently, the present invention has the effect of increasing a cleaning force.

As the cleaning force is increased as described above, the washing tub is cleaned within a relatively short period of time. Consequently, the present invention has the effect of reducing the time necessary to clean the washing tub.

Although an embodiment of the present invention has been shown and described, it would be appreciated by those skilled in the art that changes may be made in this embodiment without departing from the principles and spirit of the invention, the scope of which is defined in the claims and their equivalents.

What is claimed is:

1. A method of cleaning a washing tub mounted in a water tub of a washing machine, comprising:
supplying water necessary to clean the washing tub to the water tub; and
rotating the washing tub while supplying heat to the water tub by means of at least one heat supply device mounted in the washing machine.

2. The method according to claim 1, wherein the heat supply device is a steam device, and the washing tub is rotated while steam generated by the steam device is supplied to the water tub.

3. The method according to claim 1, wherein the heat supply device is a hot air device, and the washing tub is rotated while hot air generated by the hot air device is supplied to the water tub.

4. A method of cleaning a washing tub of a washing machine, comprising:
initially supplying a portion of washing tub cleaning water to a water tub and rotating the washing tub to perform first cleaning; and
further supplying the remainder of the washing tub cleaning water to the water tub and rotating the washing tub to perform second cleaning, wherein
heat is supplied to the water tub and the washing tub by means of at least one heat supplying device when the first and second cleaning is performed.

5. The method according to claim 4, wherein the heat supply device is a steam device, and the washing tub is cleaned while the water tub and the washing tub are heated by steam supplied from the steam device during the first cleaning.

6. The method according to claim 4, wherein the heat supply device is a hot air device, and the washing tub is cleaned while the water tub and the washing tub are heated by hot air supplied from the hot air device during the first cleaning.

7. The method according to claim 5, wherein the heat supply device further comprises a lower heater, and the washing tub is cleaned while the cleaning water is heated by the lower heater during the second cleaning.

8. The method according to claim 6, wherein the heat supply device further comprises a lower heater, and the washing tub is cleaned while the cleaning water is heated by the lower heater during the second cleaning.

9. The method according to claim 4, further comprising:
performing rinsing and dewatering operations after the second cleaning is completed.

10. A washing machine comprising:
a water tub;
a washing tub mounted in the water tub;
at least one heat supply device to supply heat to the water tub and the washing tub;
a water supply valve to control a flow of water to the water tub which is supplied to the washing tub as cleansing water; and
a microcomputer to perform a control operation of the water supply valve and the heat supply device, so that washing tub cleansing water is separately supplied several times and the washing tub is rotated while the heat supply device supplies heat to the water tub and the washing tub after each of the respective separate water supplies is completed to clean the washing tub.

11. The machine according to claim 10, wherein the heat supply device comprises a steam device, a hot air device or a lower heater.
